(19) United States
(12) Patent Application Publication
(10) Pub. No.: US 2005/0174341 A1
(43) Pub. Date: Aug. 11, 2005

(54) Electrophoretic display device

(75) Inventors: Mark Thomas Johnson, Eindhoven (NL); Guofu Zhou, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/513,272

(22) PCT Filed: Apr. 11, 2003
(86) PCT No.: PCT/IB03/01561

(30) Foreign Application Priority Data
May 6, 2002 (EP) 02076788.5

(51) Int. Cl. G09G 5/00

(52) U.S. Cl. 345/204

(57) ABSTRACT

An electrophoretic display device (1) comprises at least one pixel (10) with an electrophoretic medium, and at least two electrodes (6, 7), as well as drive means (4) via which the pixels can be brought to different optical states comprising an applicator means for applying a voltage difference between the electrodes. The grey levels of the cells are set by providing a steady low voltage to the cells. A pulse voltage may in preferred embodiments be used to bring the grey level close to the intended level.

The invention relates to an electrophoretic display device comprising at least one pixel with an electrophoretic medium, and at least two electrodes, as well as drive means via which the pixel can be brought to different optical states comprising an applicator means for applying a voltage difference between the electrodes. Where an electrode (or switching electrode) is mentioned in this application, it may be divided, if desired, into a plurality of sub-electrodes which are supplied with one and the same voltage either externally or via switching elements.

Electrophoretic display devices are based on the motion of charged, usually colored particles under the influence of an electric field between two extreme states having a different transmissivity or reflectivity. With these display devices, dark (colored) characters can be imaged on a light (colored) background, and vice versa.

Electrophoretic display devices are therefore notably used in display devices taking over the function of paper, referred to as “paper white” applications (electronic newspapers, electronic diaries).

In the known electrophoretic display devices with an electrophoretic medium between switching electrodes, the switching electrodes are supplied with drive voltages. The pixel may then be brought to a particular optical state. One of the switching electrodes is then realized, for example, as two mutually interconnected narrow conducting strips on the upper side of a display element. At a positive voltage across this switching electrode with respect to a bottom electrode covering the entire bottom surface of the display element, charged particles (negatively charged in this example) move to the potential plane which is defined by the two interconnected narrow conducting strips. The (negatively) charged particles spread across the front face of the display element (pixel) which then assumes the color of the charged particles. At a negative voltage across the switching electrode with respect to the bottom electrode, the (negatively) charged particles spread across the bottom face so that the display element (pixel) assumes the color of the liquid. Alternatively, the electrophoretic medium may comprise differently coloured particles with different charges in a transparent fluid. In this situation, the pixel colour is defined by the proportion of the coloured particles which are visible from the viewing surface.

Displaying intermediate optical states (referred to as grey values) may also be done. To this end voltage pulses are applied to the cells, wherein the time length of the voltage pulse determines the grey level.

Different types of electrophoretic displays are known, most notably there are types in which the charged particles move vertically (transverse to the plane of the pixel element and driven by two continuous electrodes) and in which the charged particles move horizontally (in-plane).

Although these displays generally function reasonably, obtaining a reliable grey scale in the displayed image, which are among the most important properties of an electrophoretic display, tends to be difficult. Within the concept of the invention ‘grey scale’ is to be understood a luminance or color value in between the extrema the cell can obtain. In a cell that is switchable between white and black, the grey scale stands for a shade of grey, however, if the cell is switched between two other colors (one for instance being the color of the liquid, the other the color of charged particles), the grey scale stands for a color rendition in between this extrema.

It is an object of the present invention to improve the grey scale display quality of the display. In an electrophoretic display device according to the invention, the applicator means are arranged for setting the grey scale of the cell by providing a steady low voltage to the cells.

Low voltage within the concept of the invention means a voltage lower than resetting voltage or the time dependent setting voltages used in conventional displays (which are typically higher than 10 Volts).

The invention is based on the recognition that in electrophoretic display when a steady lower voltage is applied, the system within the cell, i.e. the combination of fluid and charged particles, tends towards an equilibrium grey level, which thereafter remains constant even with prolonged application of the drive voltage. Such voltages are typically lower than 5 Volts. Lower voltage means within the concept of the invention a voltage lower than is usually applied to set (using time dependent pulse voltages) the grey level.

The invention is based on the insight that for the time dependent grey scale setting pulse voltages, although they do set a grey scale, the relationship between the set grey scale and the actual grey scale is dependent on many factors, which makes for the possibility that there exists a large discrepancy between the actual grey scale and the intended grey scale. Whilst the known approach does generate grey scales, its weakness is that it depends upon timing and height of the pulses to realise the grey scale. If anything occurs to modify the motion of the charged particles, for example a change in viscosity or dielectric constant of the liquid and/or particles due to a temperature variation or a change in the height of the pulse or length of the pulse due to a temperature variation, or an incomplete reset pulse, the actual grey scale will be different from the intended grey scale, i.e. be wrong.

Using an grey scale level in an equilibrium state, i.e. one set by applying a low steady voltage as in the present invention, eliminates or at least reduces these dependencies and thereby a more reliable grey scale level is obtained. If there is any temperature dependency, such dependency will be much smaller, since the rheological properties of the particles within the fluid are much less important, and thus any dependency is much easier to correct for, for instance by providing the device with as temperature sensor, a look-up table comprising the relationship between temperature, set voltage and grey level and an adjustor for adjusting the equilibrium state low voltage in correspondence with the measured temperature and the data of the look-up table.

In preferred embodiments the applicator means are arranged for applying prior to setting the grey scale of the cell by providing a steady low voltage to the cells a pulse voltage to change the grey level from the prior level to a level close to the equilibrium level.

Because of the low applied voltages, the new image will normally take a relatively long period to appear (many seconds to minutes). In addition, the image will appear in a disjointed manner, with the greyscales realised at a higher voltage appearing first. For example, if the display is first reset to a black state, the most white pixels in the new image will appear quickly, whilst darker grey scales will take even longer to appear. In order to reduce or eliminate the weaknesses mentioned the driving of the electrophoretic device is preferably provided with an overdrive function, i.e. a device, program or system to apply a pulse voltage to initially bring the grey level near the wanted grey level. It is important to note that this pulse is not used to set the grey level, the actual setting is done by the low voltage, the initiation pulse brings the grey level near the wanted equilibrium grey level. Using such an initiation pulse, in a display which has been reset to a defined black or white state it is possible to speed up the transition to the final equilibrium analogue grey scale by overdriving the display with a higher voltage for a short period (typically <1 second). The initiation pulse themselves are dependent on the desired grey level, as well as in circumstances on the initial or previous grey level. This will be further explained below.

These and other aspects of the invention are apparent from and will be elucidated with reference to the embodiments described hereinafter.

In the drawings:

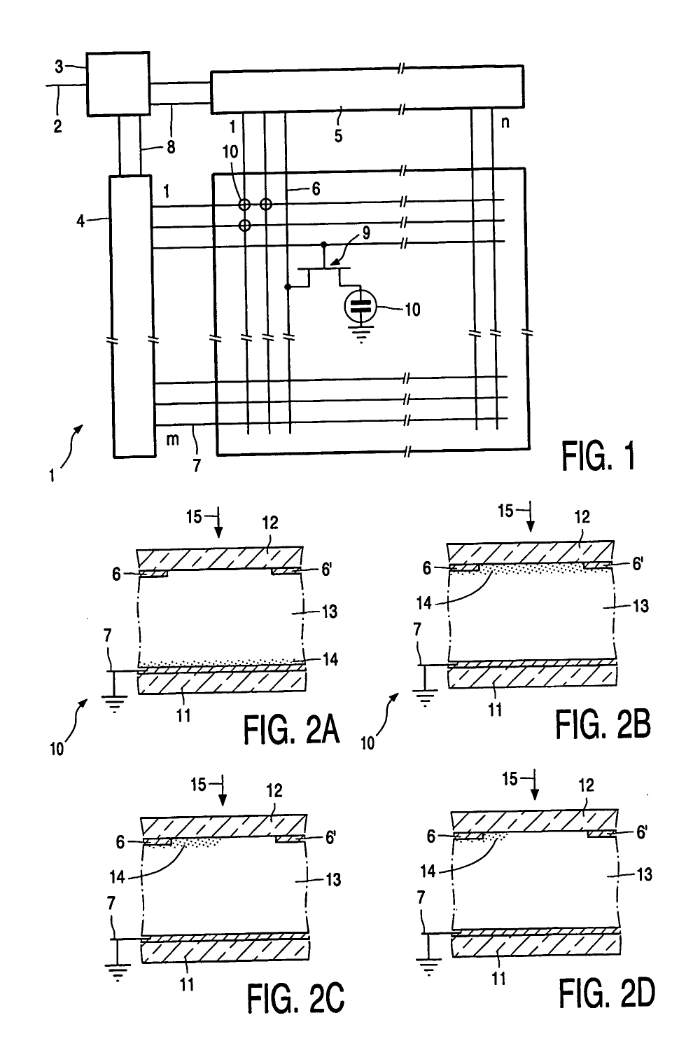

FIG. 1 shows diagrammatically a display device,

FIG. 2 shows a pixel of an electrophoretic display device in which different grey values (intermediate optical states) have been realized,

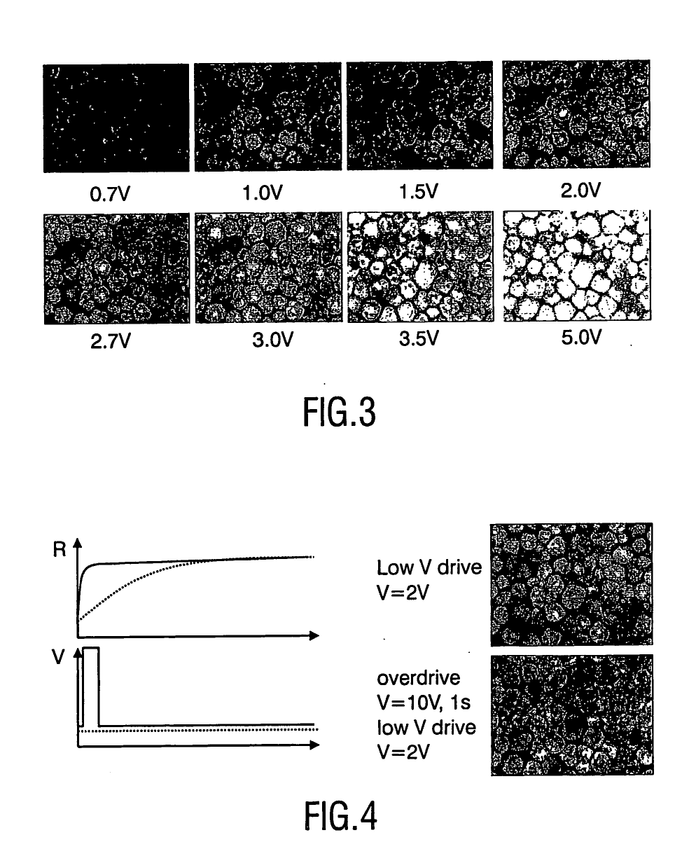

FIG. 3 illustrates microscopic views of parts of a cell after long application of a small voltage.

FIG. 4 illustrates the dependency of the grey scale on applied voltages in two embodiments of the invention.

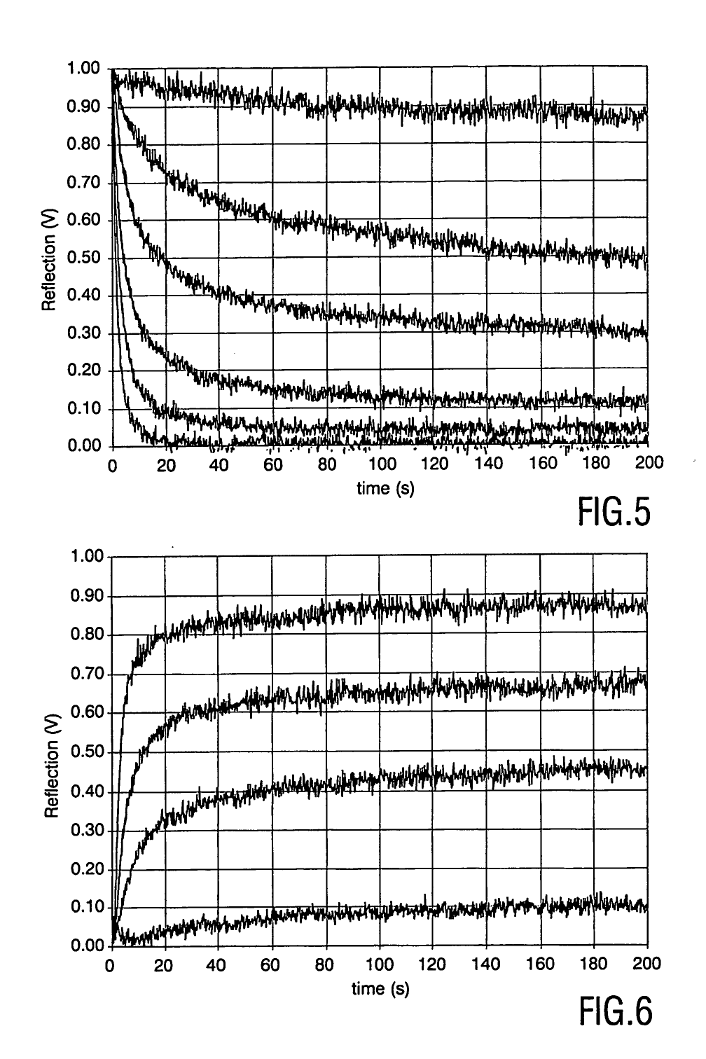

FIG. 5 shows in a graphical form grey levels obtained starting from a bright state by application of a steady low voltage

FIG. 6 shows in a graphical form grey levels obtained by starting from a black state by application of a steady low voltage

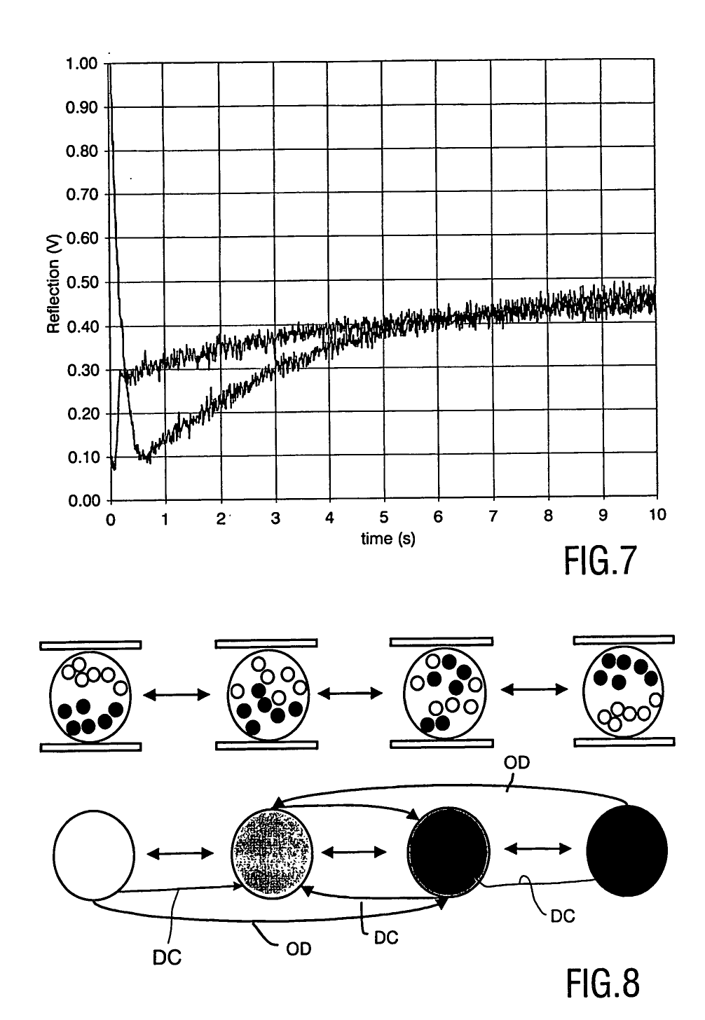

FIG. 7 illustrates in a graphical form grey levels obtained by starting from a bright and black state by application of a short high voltage pulse followed by a steady low voltage

FIG. 8 illustrates a preferred method for obtaining a grey level from a bright or a black state.

The Figures are diagrammatic and not drawn to scale; corresponding parts are generally denoted by the same reference numerals.

FIG. 1 shows an electric equivalent of a part of a display device 1 to which the invention is applicable. It comprises a matrix of pixels 10 at the area of crossings of row or selection electrodes 7 and column or data electrodes 6. The row electrodes 1 to m are consecutively selected by means of a row driver 4, while the column electrodes 1 to n are provided with data via a data register 5. To this end, incoming data 2 are first processed, if necessary, in a processor 3. Mutual synchronization between the row driver 4 and the data register 5 takes place via drive lines 8.

Drive signals from the row driver 4 and the data register 5 select a pixel 10 (referred to as passive drive). In known devices, a column electrode 6 acquires such a voltage with respect to a row electrode 7 that the pixel assumes one of two extreme states at the area of the crossing (for example, black or colored, dependent on the colors of the liquid and the electrophoretic particles).

If desired, drive signals from the row driver 4 may select the picture electrodes via thin-film transistors (TFTs) 9 whose gate electrodes are electrically connected to the row electrodes 7 and whose source electrodes 21 are electrically connected to the column electrodes 6 (referred to as active drive). The signal at the column electrode 6 is transferred via the TFT to a picture electrode, coupled to the drain electrode, of a pixel 10. The other picture electrodes of the pixel 10 are connected to, for example, ground, for example, by means of one (or more) common counter electrode(s). In the example of FIG. 1, such a TFT 9 is shown diagrammatically for only one pixel 10.

In a display device according to the invention, each pixel may also be provided with a further electrode and drive means for supplying the further electrode with electric voltages. This is shown in FIG. 2, in which a cross-section of such a pixel provided with a third electrode 6′ is shown. The drive means comprise, for example, the data register 5 (and possibly a part of the driver), and extra column electrodes 6′ (and an extra TFT in the case of active drive).

A pixel 10 (FIG. 2) comprises a first substrate 11, for example, of glass or a synthetic material, provided with a switching electrode 7, and a second, transparent substrate 12 provided with a switching electrode 6. The pixel is filled with an electrophoretic medium, for example, a white suspension 13 containing, in this example, positively charged, black particles 14. The pixel is further provided with a third electrode 6′ (and, if necessary, as described above, with drive means not shown in FIG. 2) so as to realize intermediate optical states via electric voltages across the third electrode.

For example, in FIG. 2A, the switching electrode 7 is connected to ground, while both electrodes 6, 6′ are connected to a voltage +V. The black particles 14 (positively charged in this example) move towards the electrode at the lowest potential, in this case the electrode 7. Viewed from the viewing direction 15, the pixel now has the color of the liquid 13 (which is white in this case). In FIG. 2B, the switching electrode 7 is connected to ground, while both electrodes 6, 6′ are connected to a voltage −V. The positively charged, black particles 14 move towards the lowest potential, in this case towards the potential plane defined by the electrodes 6, 6′, parallel to and just alongside the substrate 12. Viewed from the viewing direction 15, the pixel now has the color of the black particles 14.

Also in FIG. 2C, the switching electrode 7 is connected to ground. The electrode 6 is again connected to a voltage −V. However, similarly as electrode 7, the third electrode 6′ is now connected to ground. The positively charged, black particles 14 move towards the lowest potential, in this case an area around electrodes 6. This is even more strongly the case when the third electrode 6′ is connected to a voltage +V, as is shown in FIG. 2D. Viewed from the viewing direction 15, the pixel now has only partly the color of the black particles 14 and partly the color of the white liquid. A grey hue is thereby obtained (dark grey in the case of FIG. 2C and light grey in the case of FIG. 2D). The above embodiments are given as an illustration of an electrophoretic device. Several different types of electrophoretic devices are possible, types in which the charged particles move upwards and downwards (i.e. transverse to the plane of the display) or lateral (i.e. lateral to the plane of the display device). In these further embodiments, only 2 electrodes (6,7) are required to operate the pixel.

The electrophoretic medium may be present in many forms. The display device in accordance with the invention encompass embodiments in which the electrophoretic medium is present between two substrates, each of which is provided with a switching electrode, while at least one of the substrates is provided with the further electrode, as shown in FIGS. 2A to 2C. The charged particles may be present in a liquid between the substrates, but it is alternatively possible that the electrophoretic medium is present in a microcapsule. In the first-mentioned case, the pixels may be mutually separated by a barrier.

In embodiments, the electrophoretic medium is present between two substrates, each of which is provided with an electrode. The charged particles may be present in a liquid between the substrates, but it is alternatively possible that the electrophoretic medium is present in a microcapsule. In the first-mentioned case, the pixels may be mutually separated by a barrier.

For obtaining grey levels in conventional electrophoretic display devices use is made of timed pulse voltage. To this end voltage pulses are applied to the cells, wherein the time length of the voltage pulse determines the grey level. Basically a relatively very high voltage is applied over the cells, during a short period of time, which is cut up into time segments of lengths 1, 2, 4, 8, 16 times a minimum time period tₘᵢₙ etc (or other combinations). By applying a high pulse voltage over a number of such time slots (for instance 1+4+8, giving a grey level of 13) the grey level is set. Such a driving scheme is similar to driving schemes used in OLED's and PDP's. Although such a scheme works relatively well in most devices, the inventors have realized that in electrophoretic devices, the scheme encounters some problems specific to electrophoretic devices. The relationship between the set grey scale and the actual grey scale is dependent on many factors, which makes for the possibility that there exists a large discrepancy between the actual grey scale and the intended grey scale. Whilst the known approach does generate grey scales, its weakness is that it depends upon timing and height of the pulses to realise the grey scale. If anything occurs to modify the motion of the charged particles, in particular a change in viscosity or dielectric constant of the liquid and/or particles due to a temperature variation or ageing effects or a change in the height of the pulse or length of the pulse due to a temperature variation, or an incomplete reset pulse, the actual grey scale will be different from the intended grey scale, i.e. be wrong.

The inventors have realized that when applying a lower voltage than is usually applied (by means of the high pulse voltages) to set a grey level, the system within the cell tends towards an equilibrium grey level, which thereafter remains constant even with prolonged application of said voltage. This is illustrated in FIG. 3 which shows microscopic views of parts of a cell after long application of the voltages given below the respective sub-figures. The grey scale is basically not dependent on the length of reset pulses, the length of the addressing pulses, or such things as viscosity of the fluid. In this way an analogue grey scale is created which is not dependent upon the driving time and hence will be much less dependent on temperature induced viscosity variations or incomplete reset pulses.

Using an grey scale level in an equilibrium state, i.e. one set by applying a low steady voltage as in the present invention, eliminates or at least reduces these dependencies and thereby a more reliable grey scale level is obtained. If there is any temperature dependency, such dependency will be much smaller, since the rheological properties of the particles within the fluid are much less important, and thus any dependency is much easier to correct for, for instance by providing the device with as temperature sensor, a look-up table comprising the relationship between temperature, set voltage and grey level and an adjustor for adjusting the equilibrium state low voltage in correspondence with the measured temperature and the data of the look-up table.

In preferred embodiments the applicator means are arranged for applying prior to setting the grey scale of the cell by providing a steady low voltage to the cells a pulse voltage to change the grey level from the prior level to a level close to the equilibrium level.

Because of the low applied voltages, the new image will normally take a relatively long period to appear (many seconds to minutes). In addition, the image will appear in a disjointed manner, with the greyscales realised at a higher voltage appearing first. For example, if the display is first reset to a black state, the most white pixels in the new image will appear quickly, whilst darker grey scales will take even longer to appear. In order to reduce or eliminate the weaknesses mentioned the driving of the electrophoretic device is preferably provided with an overdrive function, i.e. a device, program or system to apply a pulse voltage to initially bring the grey level near the wanted grey level. It is important to note that this pulse is not used to set the grey level, the actual setting is done by the low voltage, the initiation pulse brings the grey level near the wanted equilibrium grey level. Using such an initiation pulse, in a display which has been reset to a defined black or white state it is possible to speed up the transition to the final equilibrium analogue grey scale by overdriving the display with a higher voltage for a short period (typically <1 second).

This approach is illustrated in FIG. 4, which illustrate two applications of voltages, one in which a steady low voltage is applied (dotted line and upper photo) and one in which a high voltage is applied to drive the cell close to the equilibrium value and thereafter a steady low voltage is applied (solid line and lower photo).

FIG. 5 shows a series of grey levels produced by starting from an ink reset to maximum brightness (reflectivity=1) and by applying a small positive DC voltage for a long time period (200 seconds) for from the top to the bottom 0.75 Volts, 1.5 Volts, 2.25 Volts, 3 Volts, 3.75 Volts and 4.5 Volts. In all cases, an equilibrium grey level is reached. The equilibrium brightness gets lower (darker) as the applied positive voltage increases, whilst the time to reach equilibrium increases. FIG. 6 shows a similar experiment starting from a black reset ink (reflective =0), and using a negative DC voltage of respectively from the bottom to the top −1.5 Volts, −2-25 Volts, −3 Volts and 4.5 Volts. In all cases however, whilst an equilibrium value is reached, it takes relatively long to reach this value. For this reason in preferred embodiments application of the steady low voltage is combined with a preceding overdrive pulse.

In these embodiments, a short driving pulse (the “overdrive” pulse) is applied to bring the cell close to its intended grey value and then use the DC voltage to realise a defined final value. In this way, the user gets the impression of a fast switching, whilst the DC voltage should ensure that the correct grey level is reached (but after a few seconds). An example of this is shown in FIG. 7, where we attempt to generate grey level of 0.45. From FIG. 6 it can be seen that starting from black (reflectivity=0), it is possible to realise this equilibrium level after about 100 seconds by applying −2.25V. Starting from white the time it takes to reach such a level is comparable. In FIG. 7, again starting from black, we have firstly applied an overdrive voltage of −15V for 160 msec (bringing the brightness to 0.3) and used the same DC voltage (−2.25V) to now reach the same equilibrium level after about 7 seconds.

In the same figure, we also demonstrate the behaviour when we start from a completely different initial state, namely a white state. In embodiments in which DC voltages in one direction only (negative in this example) are applied, the ink is driven to a darker state than the final brightness and then again move to equilibrium by applying a negative voltage. In this case, we have used a 15V pulse of 480 msec duration (bringing the brightness to 0.1) and used the same DC voltage (−2.25V) to now reach the same equilibrium level again after about 7 seconds. The length and strength of the pulse is chosen such that the grey level drops to below the intended grey level, whereafter application of the same negative DC voltage increases the grey level to the intended value. The time to reach equilibrium has thus been reduced by a factor of roughly 14. In these experiments it was shown that application of firstly an overdrive pulse to bring the cell close to the desired grey level (within roughly 0.15) either above or below the intended level and thereafter applying a steady DC voltage of the right signature, it is possible to reach the intended grey level starting from a white or black level within 10 seconds. On the other hand preferably the pulse preferably does not bring the grey level closer to the intended grey level than 0.02. If the overdrive pulse is too weak (short duration), the cell is relatively far removed from the desired grey level and the final level is not quite reached in the 10 seconds period (but of course far closer to the equilibrium value than if the overdrive pulse is not used). Of course, if the overdrive pulse is too strong (resulting in a too low brightness) the positive voltage cannot bring the brightness back again (in fact it will result in a very small drift towards lower brightness). If the pulse brings the grey level too close to the intended grey level, it is possible that after the pulse the grey level is ‘at the wrong side’ of the intended grey level and application of the DC steady low voltage will then result in a small shift of the grey level away from the intended grey level.

In a second set of measurements, the cell was driven to an intermediate grey level (0.66) with an 80 msec 15V pulse. Overdrive and DC was applied from this initial level. After a further 80 msec overdrive pulse and a 2.25V DC we arrive at exactly the same final brightness (0.45) as with a single overdrive pulse of 160 msec and 2.25V DC (which is the equilibrium value at 2.25V). The same agreement is found for the other driving conditions. This shows that the initial grey level is not determining the final grey level but the applied negative voltage does.

Finally, we have tried to start from black and reach equilibrium with the same positive DC value. This is not always successful. For example, if trying to switch from black (0) to dark grey (0.3), the correct equilibrium brightness was only found if the overdrive pulse caused the sample to become more than 50% white (say 0.66). If the overdrive was less than this, the final grey level was far too dark. Our interpretation is that in this situation, the overdrive pulse is insufficient to mix the particles (so that enough particles feel the electrostatic attraction of each other) and the DC defined grey level concept+overdrive scheme is less applicable. This is schematically illustrated in FIG. 8. Starting from a black state, a dark grey state (0.3) can be reached either more or less directly by applying a small negative voltage (FIG. 6), which will take some time, or application of a pulse voltage to bring the grey level to below the wanted grey level and then applying the same small negative voltage (FIG. 7) or applying a large pulse to bring the grey level to more than 50% white (>0.5) and then applying a small positive voltage. If it is tried to bring the grey level to 0.3 by application of a pulse to bring the grey level to 0.35-0.45 and then applying a small positive voltage, the resulting grey level is substantially below 0.3, i.e. too dark. So preferably the pulse voltage changes the grey level to beyond (seen from the prior level) the equilibrium level, and the prior and changed level are at either side of the 50% grey level mark. An example, starting from a black state, is in words given above. A further example, but then in a graphical form, is given in FIG. 7 starting from a white (1) state. Starting from a white (1) state, the pulse drives the reflection to 0.1 (i.e. very dark grey and, seen from the prior level (i.e. starting level) beyond the equilibrium level (i.e. the final level to be reached by the application of the low steady voltage). The changed level (0.1) and the prior level (1) lie at opposite sides of the 0.5 line.

In embodiments, the electrophoretic medium is present between two substrates, one of the substrates comprising the switching electrodes and the further electrode, notably when use is made of a lateral effect as described in “Development of In-Plane EPD”, SID 2000 Digest, pp. 24-27.

In embodiments, the switching electrodes may be comb-shaped and interdigital, and parts of the (insulated) further electrode are situated between the teeth of the two switching electrodes. Alternatively, the electrophoretic medium may be present in a prismatic structure as described in “New Reflective Display Based on Total Internal Reflection in Prismatic Microstructures”, Proc. 20^{th} IDRC conference, pp. 311-314 (2000).

The protective scope of the invention is not limited to the embodiments described.

The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

Within the concept of the invention a ‘means for applying’ is to be understood to comprise any piece of hard-ware (such a applicator), any circuit or sub-circuit designed for applying a voltage as specified as well as any piece of soft-ware (computer program or sub program or set of computer programs) designed or programmed to apply a voltage as specified or any combination of pieces of hardware and software acting as such, without being restricted to the above (below) given exemplary embodiment'

In short the invention can be described as follows:

1. An electrophoretic display device (1) comprising at least one pixel (10) with an electrophoretic medium, and at least two electrodes (6, 7), as well as drive means (4) via which the pixels can be brought to different optical states comprising an applicator means for applying a voltage difference between the electrodes, characterized in the applicator means are arranged for setting the grey scale of the cell by providing a steady low voltage to the cells.

2. An electrophoretic display device (1) as claimed in claim 1, characterized in that applicator means are arranged for applying prior to setting the grey scale of the cell by providing a steady low voltage of a cell a pulse voltage to change the grey level from the prior level to a changed level relatively close to the equilibrium level.

3. An electrophoretic display device (1) as claimed in claim 2, characterized in that the pulse voltage bring the grey level to a changed level intermediate the prior level and the equilibrium level.

4. An electrophoretic display device as claimed in claim 2, characterized in the pulse voltage changes the grey level to beyond (seen from the prior level) the equilibrium level, and the prior and changed level are at either side of the 50% grey level mark.
